(19) United States
(12) Patent Application Publication
(10) Pub. No.: US 2026/0301445 A1
(43) Pub. Date: Oct. 1, 2026

(54) IMAGE PROCESSING SYSTEM AND NON-TRANSITORY COMPUTER READABLE MEDIUM STORING PROGRAM

(71) Applicant: FUJIFILM Business Innovation Corp., Tokyo (JP)

(72) Inventor: Naoki WADA, Kanagawa (JP)

(73) Assignee: FUJIFILM Business Innovation Corp., Tokyo (JP)

(21) Appl. No.: 19/283,187

(22) Filed: Jul. 28, 2025

(30) Foreign Application Priority Data
Mar. 25, 2025 (JP) 2025-050630

(51) Int. Cl. G06V 20/70; G06V 10/25; G06V 10/44; G06V 10/60; G06V 10/74

(52) U.S. Cl. CPC G06V 20/70; G06V 10/25; G06V 10/44; G06V 10/60; G06V 10/761

(57) ABSTRACT

An image processing system includes a processor configured to: acquire a plurality of images; recognize a difference between one image and another image among the plurality of images; and add, to the other image, annotation data that reflects the recognized difference between the one image and the other image based on annotation data added to the one image to generate training data for machine learning.

### CROSS-REFERENCE TO RELATED APPLICATIONS

This application is based on and claims priority under 35 USC 119 from Japanese Patent Application No. 2025-050630 filed Mar. 25, 2025.

### BACKGROUND

### (i) Technical Field

The present invention relates to an image processing system and a non-transitory computer readable medium storing a program.

### (ii) Related Art

WO2023/074184A discloses an annotation support system for image data used for visual inspection of welded locations, the annotation support system including at least an annotation assignment unit that assigns annotations to image data, a display/input unit that visualizes and displays the processing performed in the annotation assignment unit, and a storage unit that stores the image data to which annotations have been assigned by the annotation assignment unit, the annotation assignment unit specifying locations of defective welds in the image data and labeling the locations of defective welds with the type of defective welds to assign annotations to the image data.

### SUMMARY

Training data used in supervised learning in machine learning is generated by adding information to data. The information added to the data is referred to as an annotation. Usually, work of adding annotations to data is performed manually. In a case in which the work of adding annotations to data is performed manually, the work requires a great deal of effort. Furthermore, there is a related art in which work of adding annotations to data is performed by inference based on machine learning or the like. However, in this case, in order to enable inference, a certain amount of training data to which annotations are added needs to be accumulated. In addition, the addition of annotations in this training data needs to be performed manually.

Aspects of non-limiting embodiments of the present disclosure relate to an image processing system and a non-transitory computer readable medium storing a program that reduce a workload of workers in a case in which work of adding annotations to each piece of data used as training data in machine learning is performed, compared to a case in which the work is performed manually.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image processing system including: a processor configured to: acquire a plurality of images; recognize a difference between one image and another image among the plurality of images; and add, to the other image, annotation data that reflects the recognized difference between the one image and the other image based on annotation data added to the one image to generate training data for machine learning.

### BRIEF DESCRIPTION OF THE DRAWINGS

Exemplary embodiment(s) of the present invention will be described in detail based on the following figures, wherein:

FIG. 1 is a diagram showing a configuration of an information processing apparatus to which an image processing system according to an exemplary embodiment of the present invention is applied;

FIG. 2 is a diagram showing an example of association of feature points of images performed by an association unit;

FIG. 3 is a diagram illustrating a concept of projective transformation;

FIGS. 4A and 4B are diagrams showing examples of bounding boxes to be added to images, where FIG. 4A shows an example of an image to which a bounding box is to be added, and FIG. 4B shows a state in which bounding boxes have been added to the image shown in FIG. 4A;

FIGS. 5A to 5C are diagrams showing examples of area deformation by projective transformation, where FIG. 5A is a diagram showing an example of a reference specific area,

FIG. 5B is a diagram showing an example of a target specific area, and FIG. 5C is a diagram showing an area specified by a bounding box added to a target image;

FIG. 6 is a diagram showing an example of a hardware configuration of the information processing apparatus;

FIG. 7 is a diagram showing an example of a method for imaging an object; and

FIG. 8 is a diagram showing another example of a method for imaging an object.

### DETAILED DESCRIPTION

Exemplary embodiments of the present invention will be described below with reference to the accompanying drawings.

An image processing system according to the present exemplary embodiment performs annotation on an image. Annotation refers to adding information in the form of tags, metadata, or the like to data such as text, audio, images, and moving images. The image processing system adds, to an image, information indicating a specific area in the image by using annotations. In the following description, data that adds information to an image will be referred to as annotation data, and adding annotation data to an image will be referred to as annotation work, an annotation step, or the like. The image processing system adds a bounding box to an image as annotation data.

### Apparatus Configuration

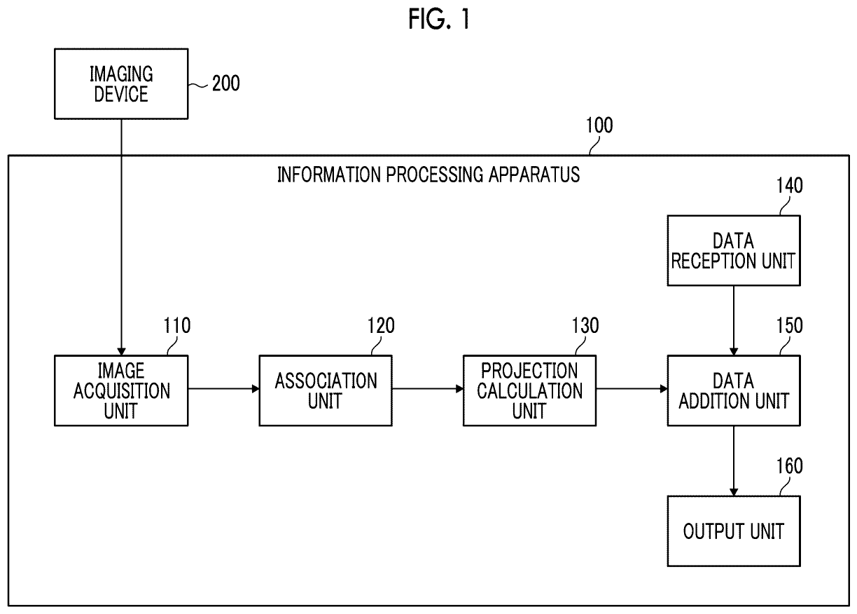

FIG. 1 is a diagram showing a configuration of an information processing apparatus to which an image processing system according to the present exemplary embodiment is applied. An information processing apparatus 100 includes an image acquisition unit 110, an association unit 120, a projection calculation unit 130, a data reception unit 140, a data addition unit 150, and an output unit 160. The information processing apparatus 100 acquires a plurality of images in which a common object is captured, and executes an annotation step on the acquired images. An image to which annotation data is to be added is, for example, an image used as training data for machine learning in which the image is used as input data. This image is captured by, for example, an imaging apparatus 200 and sent to the information processing apparatus 100. The imaging apparatus 200 is an apparatus capable of capturing an image of an object and generating and outputting digital data of the image. The imaging apparatus 200 may be, for example, a digital camera or an information terminal apparatus with a camera function, such as a smartphone.

The image acquisition unit 110 acquires a plurality of images to which annotation data is to be added. The images to be acquired are images of the identical object imaged by the imaging apparatus 200 in various positional relationships. The various positional relationships are, for example, images in which the orientation, distance, rotation angle, and the like of the object with respect to the imaging apparatus 200 that images the object are different. In addition, the images to be acquired may be not only still images but also moving images. In this case, the image acquisition unit 110 acquires images using still images by, for example, extracting the acquired moving image on a frame-by-frame basis.

The image acquisition unit 110 may select only some of the acquired images as the images to which annotation data is to be added. For example, the image acquisition unit 110 determines elements related to image quality, such as brightness, sharpness, and a color tone, for the acquired image. Then, the image acquisition unit 110 may exclude images whose brightness or sharpness is lower than a predetermined threshold value, images whose color tone is considerably different from other images, and the like from targets to which annotation data is to be added.

Out of the images acquired by the image acquisition unit 110, one image may have annotation data added by the information processing apparatus 100 added in advance. Although details will be described later, the information processing apparatus 100 receives an input operation of annotation data at the data reception unit 140. Then, the image acquisition unit 110 adds annotation data corresponding to the received input operation to one image. However, instead of adding annotation data to one image through such an input operation, the plurality of images acquired by the image acquisition unit 110 may include one image to which annotation data has been added in advance. In this case, the step of receiving an input operation of annotation data in the data reception unit 140 is not necessary.

The association unit 120 extracts feature points from each of the plurality of images acquired by the image acquisition unit 110, and associates the same feature points in each image with each other. The process of extracting feature points from an image and associating the feature points with each other is referred to as feature matching. The feature matching in the association unit 120 may be performed using various existing methods. Examples of existing methods that can be used for feature matching include scale invariant feature transform (SIFT), histograms of oriented gradients (HOG), accelerated KAZE (AKAZE), local feature matching with transformers (LOFTR), and the like.

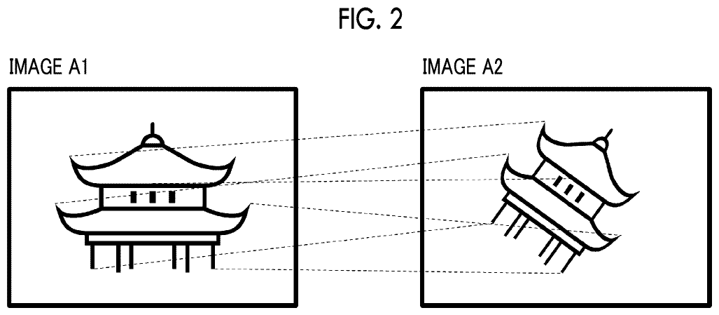

FIG. 2 is a diagram showing an example of association of feature points of images performed by the association unit 120. In the example shown in FIG. 2, it is assumed that an image A1 and an image A2 are images obtained by imaging the same object (subject). However, the image A2 differs from the image A1 in terms of the inclination, size, aspect ratio, and the like of the object. For the image A1 and the image A2, feature points are extracted using the above-mentioned existing feature matching method, and the same feature points are associated with each other. In the example shown in FIG. 2, the top of the roof, the eaves, the edges of the walls, and the like of a building, which is an object, are extracted as feature points and associated with each other. In FIG. 2, the correspondence relationship between the associated feature points is indicated by a broken line connecting corresponding points in the image A1 and the image A2. Although details will be described later, the information processing apparatus 100 estimates a homography matrix relating to the deviation of each image in the projection calculation unit 130. In order to estimate the homography matrix, it is necessary to extract at least four or more feature points that correspond to each other in each image.

The association unit 120 may use one image out of the plurality of images acquired by the image acquisition unit 110 as a reference (hereinafter, this reference image will be referred to as the “reference image”), and perform association of feature points by comparing the reference image with the other images. In a case in which the plurality of images acquired by the image acquisition unit 110 include one image to which annotation data has already been added, the one image to which annotation data has been added may be used as the reference image. In addition, in the association unit 120, feature points extracted from each image are extracted regardless of the position in the image to which the annotation data is added (or has been added). That is, the position extracted as the feature point and the position to which the annotation data is added may coincidentally match each other, but the positions may also be completely different positions.

The projection calculation unit 130 analyzes the differences between the images based on the feature points extracted by the association unit 120 in each of the plurality of images acquired by the image acquisition unit 110. More specifically, the projection calculation unit 130 sets one image out of the plurality of images acquired by the image acquisition unit 110 as a reference image, and compares the reference image with the other images individually. The projection calculation unit 130 then analyzes the differences between the reference image and each of the other images based on the differences in the positions of corresponding feature points in each image. In a case in which a reference image is set by the association unit 120, the reference image set by the association unit 120 is the reference image in the analysis by the projection calculation unit 130. In contrast, in a case in which the reference image is not set in the association unit 120, the reference image is set in the projection calculation unit 130. In the following description, each image to be compared with the reference image is referred to as a target image.

Here, in the above description of the image acquisition unit 110, it has been stated that the images acquired by the image acquisition unit 110 are images of the identical object imaged in various positional relationships. In addition, an image obtained by imaging an object is an image obtained by projecting the object in a three-dimensional space onto a two-dimensional plane (screen) at the imaging position. Therefore, the difference between the positions of corresponding feature points in the reference image and the target image is, so to speak, an image deviation based on the relationship between the object and the imaging position of the object in three-dimensional space. In a case in which the annotation target is limited to a plane, such a deviation of the target image from the reference image can be understood as a result of projective transformation with respect to the reference image. In other words, in a case in which the annotation target is limited to a plane, the correspondence relationship between feature points in the reference image and the target image is understood to be specified by projective transformation between the reference image and the target image.

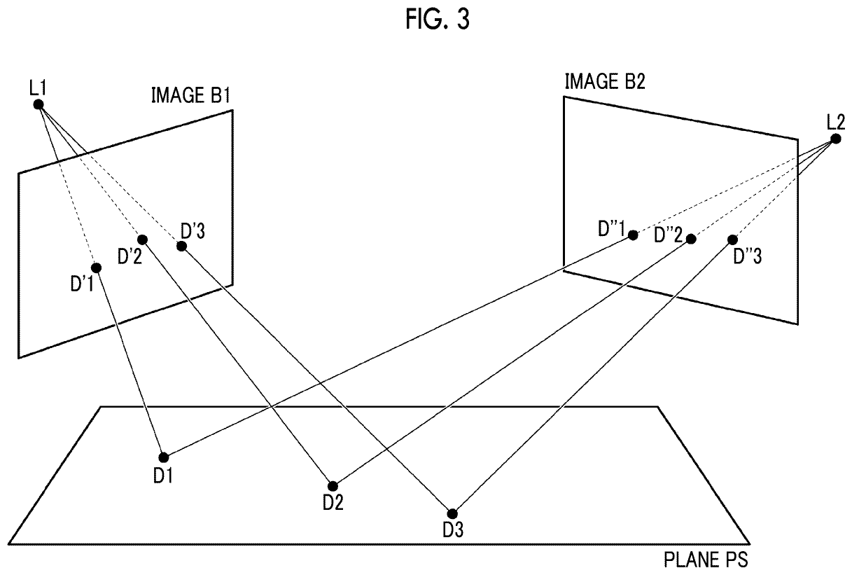

FIG. 3 is a diagram illustrating the concept of projective transformation. FIG. 3 shows a state in which three points D1, D2, and D3 provided on a plane PS are viewed from a position L1 and a position L2. The arrangement of the points (D1, D2, D3) on the plane PS is arranged as points (D′1, D′2, D′3) in an image B1 representing the state seen from the position L1. Furthermore, the arrangement of the points (D1, D2, D3) is arranged as points (D″1, D″2, D″3) in an image B2 representing the state seen from the position L2. The difference in distance and angle between the position L1 and the position L2 with respect to the plane PS causes a deviation in the position of each point in the image B1 and the image B2.

Here, a case in which any four points (xi, yi), i∈[0, 1, 2, 3] in the plane PS are mapped to four points (x′i, y′i) in another image is considered. Then, coordinate values (x′, y′) of each point in the other image are calculated as follows.

$$( \begin{matrix}{x}^{′} \\ {y}^{′}\end{matrix} ) = ( \begin{matrix}{X}^{′} / {W}^{′} \\ {Y}^{′} / {W}^{′}\end{matrix} ) \qquad [ Formula 1 ]$$

$$( \begin{matrix}{X}^{′} \\ {Y}^{′} \\ {W}^{′}\end{matrix} ) = ( \begin{matrix}{h}_{00} & {h}_{01} & {h}_{02} \\ {h}_{10} & {h}_{11} & {h}_{12} \\ {h}_{20} & {h}_{21} & 1\end{matrix} ) ( \begin{matrix}x \\ y \\ 1\end{matrix} )$$

Accordingly, by applying the above Formula 1 to the position (coordinate value) of a point on the plane PS, the position of the corresponding point in the image B1 can be calculated. Therefore, by using the above Formula 1, it is possible to estimate (perform homography estimation) how the image on the plane PS will be transformed into an image in the image B1 and to what position the image will move to. Note that, as described above, in order to derive the homography matrix used in homography estimation, it is necessary to extract at least four feature points in each target image that correspond to the feature points extracted from the reference image.

As described above, the projection calculation unit 130 obtains a homography matrix for each combination of the reference image and each target image, and estimates the deviation of each target image from the reference image. Although the details will be described later, the image deviation estimation is used to specify the position and the shape of annotation data in a case in which the annotation data is added to the target image by the data addition unit 150.

The data reception unit 140 receives annotation data input by a user. The information processing apparatus 100 automatically adds, to a plurality of target images, annotation data corresponding to the annotation data added to the reference image. Therefore, annotation data is added to the reference image in response to a user operation. The data reception unit 140 receives the operation of the user for the annotation work. A specific operation performed by the user in a case of adding annotation data to a reference image will be described later. Note that the annotation data for the reference image may be added before the reference image is acquired by the image acquisition unit 110. For example, a configuration may be employed in which an annotation step is performed on one image serving as a reference image by an apparatus other than the information processing apparatus 100, and the image acquisition unit 110 acquires the image with annotation data added.

The data addition unit 150 executes an annotation step on the image. The annotation step by the data addition unit 150 includes a first process of adding annotation data to a reference image, and a second process of automatically adding annotation data to a target image. The first process is a process of adding annotation data to a reference image based on a user operation received by the data reception unit 140. As described above, in a case of acquiring a reference image to which annotation data has been added in advance, the data reception unit 140 does not receive the annotation work operation of the user, and the data addition unit 150 does not execute the first process. The annotation step performed by the data addition unit 150 will be described in detail later.

The output unit 160 outputs the plurality of images (the reference image and the target image) to which the annotation data has been added by the data addition unit 150. The plurality of images to which annotation data has been added by the information processing apparatus 100 are used, for example, as training data for training a machine learning model that detects items in images.

### Bounding Box

The information processing apparatus 100 adds annotation data to the reference image and a plurality of target images by the data addition unit 150. For reference images, the information processing apparatus 100 adds annotation data to the image in accordance with a user operation. On the other hand, the information processing apparatus 100 automatically adds annotation data to the target image based on the annotation data added to the reference image. There are several types of annotations for images, such as bounding boxes, segmentation, and key points. In the present exemplary embodiment, with a view to creating training data for machine learning, an area is designated in an image, and annotation data is added to specify parts or components that are present in the designated area. Therefore, in the present exemplary embodiment, a bounding box is added to an image as annotation data.

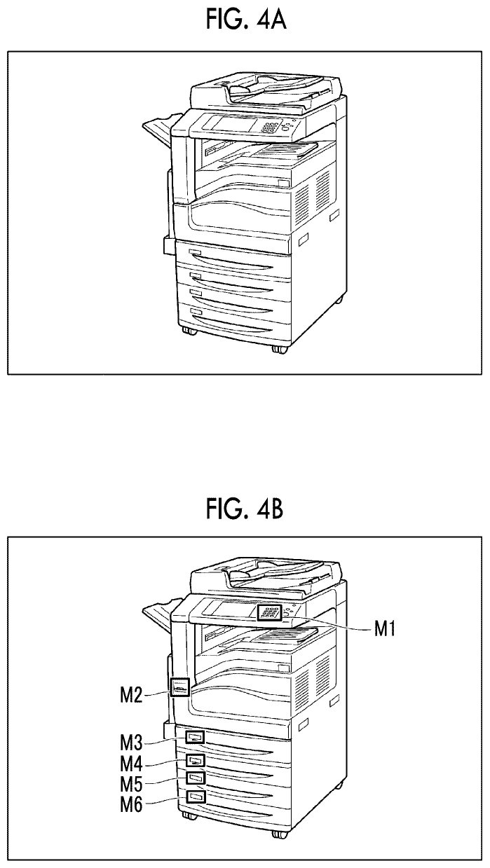

FIGS. 4A and 4B are diagrams showing examples of bounding boxes to be added to images, where FIG. 4A shows an example of an image to which a bounding box is to be added, and FIG. 4B shows a state in which bounding boxes have been added to the image shown in FIG. 4A. FIG. 4A shows an image obtained by imaging an image forming apparatus. FIG. 4B shows a state in which six bounding boxes M1 to M6 are added to the image forming apparatus.

A bounding box is annotation data that encloses a specific area in an image with a rectangle and adds information indicating parts or components that are present in the enclosed area. In the example shown in FIG. 4B, six areas of the image forming apparatus are indicated by six bounding boxes M1 to M6. In the example shown in FIG. 4B, for example, the bounding box M1 encloses a numeric keypad provided on an operation panel of the image forming apparatus. That is, the bounding box M1 indicates the position of the numeric keypad in the image forming apparatus and that the numeric keypad is provided at the position. Furthermore, the bounding box M2 encloses a human presence sensor that is provided on the front side of the image forming apparatus and is used to detect an operator. That is, the bounding box M2 indicates the position of the human presence sensor in the image forming apparatus and that the human presence sensor is provided at the position. Furthermore, the bounding boxes M3 to M6 respectively enclose four labels provided on the trays at the bottom of the image forming apparatus, each of which indicates the size of paper to be set in the corresponding tray. That is, each of the bounding boxes M3 to M6 indicates the position of a label provided on a tray of the image forming apparatus and the label provided at the position.

In the example shown in FIG. 4B, the bounding boxes are expressed as rectangular images drawn with thick lines. In a case in which a user adds a bounding box to an image or checks an image with a bounding box added, the image is displayed such that the bounding box can be visually recognized, as shown in FIG. 4B, for example. However, a bounding box is information that allows a computer to recognize parts or components that are present in a specific area in a case of processing an image. Therefore, the data on the bounding box is generated as data such as coordinate values that represent the position and the shape of the rectangular area that is the bounding box, for example.

### Annotation Work

Next, annotation work in the information processing apparatus 100 will be described. First, an operation of adding annotation data to a reference image through a user operation will be described. The data addition unit 150 of the information processing apparatus 100 receives an input operation from the user via the data reception unit 140, and adds a bounding box to the reference image in accordance with the an input operation from the user. A specific operation for adding bounding boxes is performed, for example, as follows.

First, the information processing apparatus 100 displays a reference image on a display device. The user operates an input device such as a pointing device or a keyboard to draw a rectangular frame at a position on the reference image displayed on the display device where the bounding box is to be added. Furthermore, the user may input information about the part or component indicated by the bounding box (hereinafter referred to as “class information”).

In a case in which the above operations are performed, the data addition unit 150 retains data specifying the position and the shape of the rectangular frame drawn in the reference image as information on the bounding box added to the reference image through the above operations. The information on the bounding box is expressed, for example, by coordinate values in the reference image. Furthermore, in a case in which a plurality of bounding boxes are set for the reference image, identification information for identifying each bounding box is assigned to the bounding box. The identification information may be any information that can uniquely identify each bounding box, and may be, for example, a numerical value or the like assigned in sequence to each bounding box. The data addition unit 150 retains the identification information on each bounding box in association with the information (such as coordinate values) on the corresponding bounding box.

Furthermore, in a case in which class information is input together with the bounding boxes, the data addition unit 150 associates the information and identification information on each bounding box with the input class information. Then, the data addition unit 150 retains a data set including the associated information on the bounding box and class information as data on the bounding box added to the reference image through the above operation. In this manner, a bounding box is added as annotation data to one reference image by the user's manual work.

Next, an operation of automatically adding bounding boxes as annotation data to a plurality of target images based on a reference image to which a bounding box has been added will be described. As described above, the reference image and the plurality of target images are images of the identical object imaged in various positional relationships. Therefore, the position and the shape of a specific area in the reference image will be different for each target image, with the area being in a different position and shape.

As stated in the description of the projection calculation unit 130, the deviation of each target image from the reference image is understood as the result of projective transformation of the reference image. Therefore, the position and the shape of an area in the target image that corresponds to a specific area in the reference image is estimated by homography estimation using the homography matrix derived by projection calculation unit 130.

Hereinafter, an area in the reference image to which a bounding box has been added is referred to as a “reference specific area”, and an area in the target image corresponding to the reference specific area is referred to as a “target specific area”. As described above, the target specific area of the target image is an area that is located at a different position and has a different shape from the reference specific area in the reference image. The shape of the reference specific area was a rectangle corresponding to the shape of the bounding box. On the other hand, the shape of the target specific area can be any of a variety of quadrangles (trapezoid, parallelogram, irregular quadrilateral, and the like). That is, in a target image, the shape of the target specific area and the shape of the bounding box, which is rectangular, usually do not match.

The shape of the target specific area will be described in further detail. As an example, it is assumed that the position and the shape (aspect ratio) of a rectangular bounding box are specified by the coordinate values of the four vertices of the bounding box. The shape of the reference image is a rectangle specified by a bounding box. Therefore, the position and the shape of the reference specific area are specified by the coordinate values of the above four vertices. Then, the position and the shape of the target specific area in the target image is a quadrangle whose vertices are four coordinate values (hereinafter referred to as “transformed coordinate values”) obtained by performing homography estimation on the coordinate values of the four vertices of the reference specific area. As described above, this quadrangle as the target specific area is usually not rectangular. Therefore, it is not possible to add a rectangular bounding box in the target image that matches the non-rectangular target specific area.

Therefore, the data addition unit 150 adds, to the target image, a rectangular bounding box that contains the four transformed coordinate values related to the four vertices of the target specific area. More specifically, a rectangle serving as a bounding box added to the target image contains four transformed coordinate values in the rectangle. In this case, one to four of four transformed coordinate values may be on any side of the rectangle serving as the bounding box.

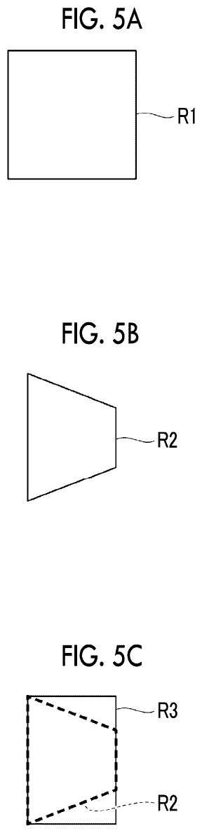

FIGS. 5A to 5C are diagrams showing examples of area deformation by projective transformation, where FIG. 5A is a diagram showing an example of a reference specific area, FIG. 5B is a diagram showing an example of a target specific area, and FIG. 5C is a diagram showing an area specified by a bounding box added to a target image. As shown in FIG. 5A, the reference specific area in the reference image is a rectangular area R1 that corresponds to the bounding box. Although not shown, it is assumed that a component specified by a bounding box is present in the area R1 in FIG. 5A.

Next, in a certain target image, it is assumed that an area corresponding to the reference specific area R1 of the reference image is deformed into a trapezoidal area R2 as shown in FIG. 5(B), for example. In this case, a component that is present in the reference specific area R1 in the reference image will be present in the trapezoidal area R2 in the target image.

The data addition unit 150 adds, to the target image, a bounding box that encloses a rectangular area R3 that contains the area R2. Since the area R3 defined by the bounding box contains the area R2, any components that are present in the reference specific area R1 in the reference image will be present in the area R3 in the target image.

In this manner, the data addition unit 150 adds, to each target image, bounding boxes corresponding to all of the bounding boxes added to the reference image. In a case in which a plurality of bounding boxes are added to each image, identification information is assigned to each bounding box in each target image. The identification information on the bounding box in the target image is information that corresponds to the identification information assigned to each corresponding bounding box in the reference image. Depending on the three-dimensional shapes of the objects displayed in the reference image and the target image, in some cases, certain parts of the object are hidden by other parts. In a case in which a bounding box is added to such a part in the reference image, it may happen that the part to which the bounding box is to be added is not displayed in the target image. In this case, it is not possible to add a bounding box to the corresponding part. Such an image is excluded from the target images.

### Example of Hardware Configuration of Information Processing Apparatus 100

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

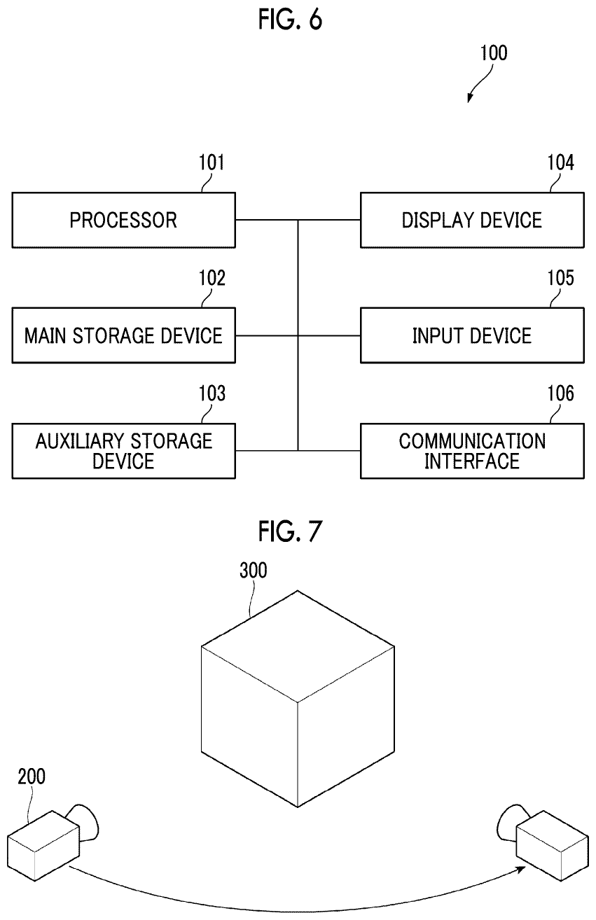

FIG. 6 is a diagram showing an example of a hardware configuration of the information processing apparatus 100. The information processing apparatus 100 includes a processor 101, a main storage device 102, an auxiliary storage device 103, a display device 104, an input device 105, and a communication interface 106. The processor 101 is an example of the above-described processor. The main storage device 102 is a working memory used in a case in which the processor 101 executes processing. The auxiliary storage device 103 is a storage device that retains programs executed by the processor 101, setting information used in processing by the processor 101, and the like. As the main storage device 102, for example, a random access memory (RAM) is used. As the auxiliary storage device 103, for example, a magnetic disk device or a solid state drive (SSD) is used.

The display device 104 displays various screens. For example, a liquid crystal display or the like is used as the display device 104. The display device 104 displays a reference image and a target image in a case in which annotation work is performed. The input device 105 is a device that a user operates to input data or commands. As the input device 105, for example, a pointing device such as a mouse, a keyboard, or the like is used. The communication interface 106 is an interface for connecting the information processing apparatus 100 to an external device.

In the information processing apparatus 100 shown in FIG. 1, the functions of the association unit 120, the projection calculation unit 130, and the data addition unit 150 are implemented, for example, by the processor 101 shown in FIG. 6 executing a program. The functions of the image acquisition unit 110 and the output unit 160 are implemented by, for example, the processor 101 and the communication interface 106 shown in FIG. 6. In addition, the data reception unit 140 is implemented by, for example, the processor 101, the display device 104, and the input device 105 shown in FIG. 6.

### Image Capturing Method

The information processing apparatus 100 acquires a plurality of images in which a common object is imaged, and adds bounding boxes as annotation data to the acquired images. The plurality of images are images of the identical object imaged by the imaging apparatus 200 in various positional relationships. Specifically, in a case in which an object is imaged by the imaging apparatus 200, the imaging apparatus 200 is moved around the object while imaging the object, or the orientation of the object is changed while imaging the object.

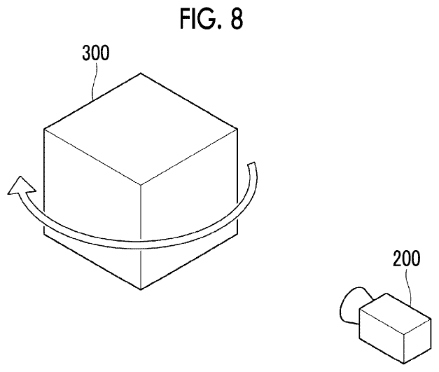

FIG. 7 is a diagram showing an example of a method for imaging an object. In the example shown in FIG. 7, the imaging apparatus 200 is directed to an object 300 and is moved around the object 300 while imaging the object 300. Accordingly, a plurality of images are obtained in which the object 300 is oriented in different directions with respect to the optical axis of the imaging apparatus 200. The imaging method shown in FIG. 7 may be used, for example, in a case in which the size of the object 300 is large and it is difficult to move or rotate the object 300. In the example shown in FIG. 7, a state in which the imaging apparatus 200 images the object 300 while moving the imaging apparatus 200 in a direction along a two-dimensional plane is shown. In contrast, the object 300 may be imaged while the imaging apparatus 200 is moved in various directions in a three-dimensional space. Further, the object 300 may be imaged while moving the imaging apparatus 200 closer to or farther away from the object 300.

FIG. 8 is a diagram showing another example of a method for imaging an object. In the example shown in FIG. 8, the imaging apparatus 200 is fixed, and the object 300 is imaged while being rotated. Accordingly, a plurality of images are obtained in which the object 300 is oriented in different directions with respect to the optical axis of the imaging apparatus 200. The imaging method shown in FIG. 8 may be used, for example, in a case in which the size of the object 300 is small and it is easy to move or rotate the object 300. In the example shown in FIG. 8, a state in which the object 300 is imaged while being rotated around one rotation axis is shown. In contrast, the object 300 may be imaged while rotating the object 300 around a plurality of rotation axes, or while tilting the rotation axes themselves. Further, the object 300 may be imaged while rotating the object 300 and moving the imaging apparatus 200 closer to or farther away from the object 300.

Although the exemplary embodiment of the present invention has been described above, the technical scope of the exemplary embodiment of the present invention is not limited to the above exemplary embodiment. For example, in the above exemplary embodiment, a bounding box that specifies a rectangular area is used as annotation data. However, the annotation data used in the present exemplary embodiment is not limited to a bounding box as long as the annotation data can designate a specific area within an image as training data for machine learning. For example, the bounding box may be replaced with segmentation, annotation data specifying a circular area, or the like. In addition, various modifications and alternative configurations are involved in the present invention without departing from the technical scope of the present invention. The present invention can also be applied to programs and program products.

### Supplementary Note

(((1)))

An image processing system comprising:
a processor configured to:
   acquire a plurality of images;
   recognize a difference between one image and another image among the plurality of images; and
   add, to the other image, annotation data that reflects the recognized difference between the one image and the other image based on annotation data added to the one image to generate training data for machine learning.
      (((2)))

The image processing system according to (((1))), wherein the processor is configured to:
specify, for the other image, an area corresponding to an area in the one image specified by the annotation data, and add annotation data to the corresponding area.
   (((3)))

The image processing system according to (((1))) or (((2))),
wherein the annotation data is information indicating a specific area in an image, and
the processor is configured to:
   convert the information indicating the specific area in the one image into information indicating an area in the other image corresponding to the specific area and add the information to the other image.
      (((4))

The image processing system according to any one of (((1) to (3)
wherein the information indicating the specific area is a bounding box, and
the processor is configured to:
   add a bounding box to a corresponding area that is an area of the other image corresponding to an area in the one image to which the bounding box is added, the bounding box containing the corresponding area deformed by converting the information indicating the area in the image.
      (((5)))

The image processing system according to any one of (((1))) to (((4))), wherein the processor is configured to:
in a case in which areas corresponding to all areas specified by the annotation data in the one image are not able to be specified in the other image, exclude the other image from a target of a process of adding annotation data.
   ((6))

The image processing system according to any one of (((1))) to (((5))),
wherein the plurality of images are images obtained by imaging an identical object, and
the processor is configured to:
   extract feature points in each of the plurality of images; and
   specify a relationship between the one image and the other image by regarding a difference between the feature points in the one image and the other image as an image deviation based on a relationship between the object and an imaging position of the object in a three-dimensional space.
      (((7)))

The image processing system according to (((6))), wherein the processor is configured to:
specify the relationship between the one image and the other image by regarding the difference between the feature points in the one image and the other image as at least an image deviation based on a difference in orientation of the object with respect to the imaging position in the three-dimensional space.
   (((8)))

The image processing system according to (((6))) or (((7))), wherein the processor is configured to:
specify the relationship between the one image and the other image by regarding the difference between the feature points in the one image and the other image as at least an image deviation based on a difference in distance between the object and the imaging position in the three-dimensional space.
   ((9))

The image processing system according to any one of (((1))) to (((8))), further comprising:
a storage device that retains the plurality of images,
wherein the processor is configured to:
   select, as the other image, an image that satisfies a specific condition from among the plurality of images retained in the storage device.
      (((10)))

The image processing system according to (((9))), wherein the processor is configured to:
select an image that satisfies a set condition regarding brightness of an object in the image as the other image.
   (((11)))

The image processing system according to (((9))) or (((10))), wherein the processor is configured to:
select an image that satisfies a set condition regarding sharpness of an object in the image as the other image.
   (((12)))

The image processing system according to any one of (((1))) to ((11))), wherein the processor is configured to:
receive an operation of annotation work by a user regarding the one image among the plurality of images;
add the annotation data to the one image in accordance with the operation; and
add annotation data to the plurality of images excluding the one image based on the annotation data added to the one image.
   (((13)))

The image processing system according to any one of (((1))) to (((12))),
wherein the plurality of images are images obtained by imaging an identical object, and
the processor is configured to:
   extract feature points in each of the plurality of images; and
   specify a correspondence relationship between the feature points in the one image and the other image by projective transformation between the one image and the other image.
      (((14)))

An image processing system comprising:
a processor configured to:
   acquire a plurality of images in which a common object is imaged;
   extract corresponding feature points in each of the plurality of images;
   recognize a difference between one image and another image based on a correspondence relationship between the feature points; and
   add, to the other image, annotation data that reflects the recognized difference between the one image and the other image based on annotation data added to the one image.
      (((15)))

A program causing a computer to implement:
a function of acquiring a plurality of images;
a function of recognizing a difference between one image and another image among the plurality of images; and
a function of adding, to the other image, annotation data that reflects the recognized difference between the one image and the other image based on annotation data added to the one image to generate training data for machine learning.
   (((16)))

A program causing a computer to implement:
a function of acquiring a plurality of images in which a common object is imaged;
a function of extracting corresponding feature points in each of the plurality of images;
a function of recognizing a difference between one image and another image based on a correspondence relationship between the feature points; and
a function of adding, to the other image, annotation data that reflects the recognized difference between the one image and the other image based on annotation data added to the one image.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing system comprising:
a processor configured to:
acquire a plurality of images;
recognize a difference between one image and another image among the plurality of images; and
add, to the other image, annotation data that reflects the recognized difference between the one image and the other image based on annotation data added to the one image to generate training data for machine learning.

2. The image processing system according to claim 1, wherein the processor is configured to:
specify, for the other image, an area corresponding to an area in the one image specified by the annotation data, and add annotation data to the corresponding area.

3. The image processing system according to claim 2,
wherein the annotation data is information indicating a specific area in an image, and
the processor is configured to:
convert the information indicating the specific area in the one image into information indicating an area in the other image corresponding to the specific area and add the information to the other image.

4. The image processing system described in claim 3,
wherein the information indicating the specific area is a bounding box, and
the processor is configured to:
add a bounding box to a corresponding area that is an area of the other image corresponding to an area in the one image to which the bounding box is added, the bounding box containing the corresponding area deformed by converting the information indicating the area in the image.

5. The image processing system according to claim 2, wherein the processor is configured to:
in a case in which areas corresponding to all areas specified by the annotation data in the one image are not able to be specified in the other image, exclude the other image from a target of a process of adding annotation data.

6. The image processing system according to claim 1,
wherein the plurality of images are images obtained by imaging an identical object, and
the processor is configured to:
extract feature points in each of the plurality of images; and
specify a relationship between the one image and the other image by regarding a correspondence relationship between the feature points in the one image and the other image as an image deviation based on a relationship between the object and an imaging position of the object in a three-dimensional space.

7. The image processing system according to claim 6, wherein the processor is configured to:
specify the relationship between the one image and the other image by regarding the correspondence relationship between the feature points in the one image and the other image as at least an image deviation based on a difference in orientation of the object with respect to the imaging position in the three-dimensional space.

8. The image processing system according to claim 6, wherein the processor is configured to:
specify the relationship between the one image and the other image by regarding the correspondence relationship between the feature points in the one image and the other image as at least an image deviation based on a difference in distance between the object and the imaging position in the three-dimensional space.

9. The image processing system according to claim 1, further comprising:
a storage device that retains the plurality of images,
wherein the processor is configured to:
select, as the other image, an image that satisfies a specific condition from among the plurality of images retained in the storage device.

10. The image processing system according to claim 9, wherein the processor is configured to:
select an image that satisfies a set condition regarding brightness of an object in the image as the other image.

11. The image processing system according to claim 9, wherein the processor is configured to:
select an image that satisfies a set condition regarding sharpness of an object in the image as the other image.

12. The image processing system according to claim 1, wherein the processor is configured to:
receive an operation of annotation work by a user regarding the one image among the plurality of images;
add the annotation data to the one image in accordance with the operation; and
add annotation data to the plurality of images excluding the one image based on the annotation data added to the one image.

13. The image processing system according to claim 1,
wherein the plurality of images are images obtained by imaging an identical object, and
the processor is configured to:
extract feature points in each of the plurality of images; and
specify a correspondence relationship between the feature points in the one image and the other image based on a deviation between the one image and the other image.

14. An image processing system comprising:
a processor configured to:
acquire a plurality of images in which a common object is imaged;
extract corresponding feature points in each of the plurality of images;
recognize a difference between one image and another image based on a correspondence relationship between the feature points; and
add, to the other image, annotation data that reflects the recognized difference between the one image and the other image based on annotation data added to the one image.

15. A non-transitory computer readable medium storing a program causing a computer to implement:
a function of acquiring a plurality of images;
a function of recognizing a difference between one image and another image among the plurality of images; and
a function of adding, to the other image, annotation data that reflects the recognized difference between the one image and the other image based on annotation data added to the one image to generate training data for machine learning.
